(19) United States
(12) Patent Application Publication
(10) Pub. No.: US 2023/0413748 A1
(43) Pub. Date: Dec. 28, 2023

(54) SIPHON PIPE, CONTAINER UNIT FOR HYDROPONICS, AND CONTAINER ASSEMBLY FOR HYDROPONICS

(71) Applicant: Yeh Kai HSU, TAICHUNG CITY (TW)

(72) Inventor: Yeh Kai HSU, TAICHUNG CITY (TW)

(21) Appl. No.: 18/463,054

(22) Filed: Sep. 7, 2023

Related U.S. Application Data
(63) Continuation-in-part of application No. 17/341,739, filed on Jun. 8, 2021.

(30) Foreign Application Priority Data
Jul. 6, 2020 (TW) 109208576

(51) Int. Cl. A01G 31/02; F16L 43/00

(52) U.S. Cl. CPC A01G 31/02; F16L 43/00

(57) ABSTRACT

A siphon pipe applied to a container unit for hydroponics comprising a pipe which is an integrated molded U-shaped body, the pipe having a U-section and two straight sections, the U-section having a continuously varying cross-sectional profile with a long axial length which gradually increases from one end toward the top, and then gradually decreases from the top toward the other end, thereby forming a continuously varying cross-sectional profile of the U-section. When the water level in the container unit rises to the U-section of the siphon pipe, the water level in the siphon pipe rises rapidly and flows to the outlet of the siphon pipe, and at the same time the air inside the pipe is brought out, to achieve a high-efficiency siphoning effect.

### FIELD OF INVENTION

The present disclosure relates to a container assembly for hydroponics, in particular a container assembly for hydroponics characterized by water conservation.

### BACKGROUND OF THE INVENTION

The cultivation of agricultural crops has been affected by the poor natural environment and unstable climate, causing many crops to suffer from natural disasters, insect pests, environmental pollution and other uncontrollable factors. In order to improve the above-mentioned shortcomings, plant cultivation equipment with LED artificial light sources in a controllable indoor environment has gradually developed.

Hydroponics is an alternative way to grow plants, for example, the planting substrate sponge is placed in the hole of the floating device (usually styrofoam), and the plant is planted in the sponge. In order for plants to absorb enough nutrients, the irrigation motor must operate for a long time every day to transport the water and nutrient solution to the required breeding pot, which causes the power consumption of the motors.

Currently, within certain recognized container units for hydroponics, a siphon pipe is utilized to operate a container assembly for hydroponics. One example is China Patent No. CN105660352A, where the hydroponic equipment employs a siphon pipe 90 with identical diameters for its two straight sections and a U-shaped section (as shown in FIG. 1a). Another example is U.S. Pat. No. 9,565,811, wherein a siphon pipe 90 comprises a first connecting pipe, a U-shaped pipe, and a second connecting pipe (as shown in FIG. 2a).

Referring to FIGS. 1b and 2b simultaneously, when utilizing the container unit and container assembly for hydroponics with the siphon pipe 90 disclosed in the previous patents are used, the U-section of the siphon pipe 90 will accumulate air and form an air chamber 901, resulting in a lower flow rate and volume of water, and when the water intake is insufficient, the siphoning effect cannot be activated, resulting in the water being discharged along the wall of the siphon pipe 90 in an overflow mode to the lower row, further resulting in the water intake of the lower row of the siphon pipe 90 being insufficient for siphoning, thus rendering the entire container assembly for hydroponics unable to operate normally.

If the aforementioned siphon pipe is intended to maintain the regular operation of the hydroponic container assembly, increased water intake becomes necessary to achieve the desired siphoning effect. Consequently, the issue of preventing the formation of air chambers within the siphon pipe, thereby conserving water and ensuring the continued functionality of the container assembly, is a challenge that needs to be addressed today.

### SUMMARY OF THE INVENTION

In consideration of the above deficiencies, the purpose of the present disclosure is to provide a container assembly for hydroponics, in particular a container assembly for hydroponics which is characterized by water conservation.

According to the purpose of the present disclosure, there is provided a container assembly for hydroponics comprising a plurality of container units, a water tank, and a shelve, wherein each of the container units comprises a container having an overflow unit and an outflow unit, the overflow unit having an overflow tube, and the outflow unit having a siphon pipe which is an integrally molded U-shaped pipe including both of a U-section and two straight sections, the U-section having a continuously varying cross-sectional profile and having the longest length of the long axis at the top position, and the height of the U-section not exceeding the height of an inlet of the overflow tube; wherein the shelve is provided with a frame at one side of the water tank and extends upwardly having a plurality of transverse bars arranged in a matrix arrangement, and a feeding tube corresponding to of the transverse bar having one end connected to a sinking motor in the water tank. Wherein, the container units are spaced apart on each of the transverse bars so that the container units are arranged in a matrix arrangement on the frame, and the feeding tube is provided with a dripping tube corresponding to a second inlet of each container unit on the uppermost row, and the overflow tube of the overflow unit of each container unit which is not on the uppermost row is connected to a first inlet corresponding to each of the container units on the next row, and an outflow tube of the container of each container unit which is not on the uppermost row is connected to a second inlet corresponding to each of the container units on the next row.

Wherein, the U-section of the siphon pipe has the shortest length of the long axis at the two joint locations connecting the two straight sections.

Wherein, the cross-sectional area at any position of the U-section of the siphon pipe is substantially the same as the cross-sectional area of the two straight sections.

Wherein, the cross-sectional profile of the U-section of the siphon pipe is in the shape of a flat ellipse, and the cross-sectional profiles of the two straight sections are in the shape of a circle.

Wherein, the position of a water inlet of the overflow tube is between the top of the U-section of the siphon pipe and a lower edge of an opening of the container.

Wherein, the height of the siphon pipe is adjustable.

Wherein, an end of the first straight section of the siphon pipe is an inlet, an end of the second straight section of the siphon pipe is inserted into an outlet which is formed through an underside of the container.

Wherein, a cover for closing the opening of the container, and a pot engaged with an opening of the cover.

Wherein, the cover has a first hole and a second hole.

Wherein, the cover has a top surface and a beveled surface, the angle between the top surface and the beveled surface being between 35 and 40 degrees.

Wherein, the angle between the top surface and the beveled surface being 37 degrees.

Wherein, a concaved and curved face is formed to a front face of the container.

Wherein, at least two light parts are connected to the transverse bar, each light part includes a light tube.

Wherein, the height of the light part is adjustable.

The advantages of the present disclosure are that the shelves provide multiple rows of containers so as to increase production rate. The inclined top face of each container allow the plant to face toward the light.

The height of the siphon pipe of each container can be adjusted according to different plant so as to prevent the plant roots from being rotted.

The siphon effect of each container is able to reduce the consumption of electricity and save operation time of the motors.

The light parts are easily installed to the shelves and provide sufficient light to the plants such that the plants grow normally regardless of the seasons.

### BRIEF DESCRIPTION OF THE DRAWINGS

FIGS. 1a, 1b, 2a, and 2b are schematic diagrams of the prior art of the present disclosure.

FIG. 3 is a cross-sectional view of the siphon pipe of the present disclosure.

FIG. 4 is a schematic diagram of the siphon pipe of the present disclosure in drainage operation.

FIG. 5 is a three-dimensional view of the container unit for hydroponics of the present disclosure.

FIG. 6 is an exploded view of the container unit for hydroponics of the present disclosure.

FIG. 7 is a cross-sectional view of the container unit for hydroponics of the present disclosure.

FIG. 8 is a schematic diagram of the container unit for hydroponics of the present disclosure for adjusting the height of the siphon pipe.

FIGS. 9 and 10 are diagrams showing the implementation of the container assembly for hydroponics of the present disclosure.

FIGS. 11a, 11b, and 11c are schematic diagrams of the water flow of the container assembly for hydroponics.

### DETAILED DESCRIPTION OF THE PREFERRED EMBODIMENTS

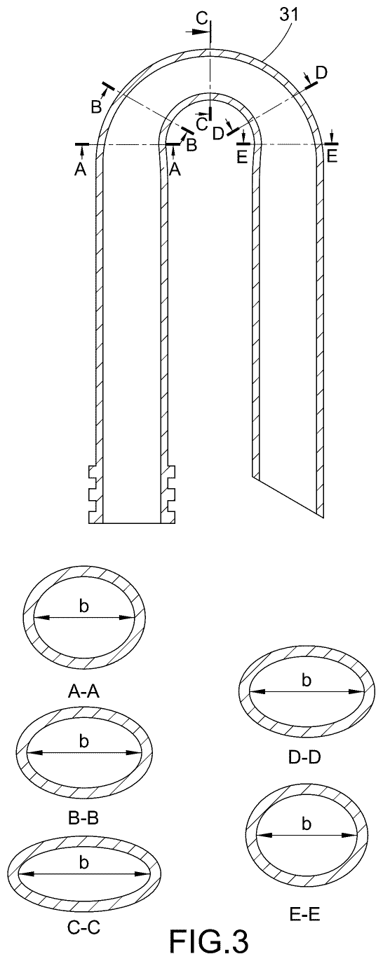

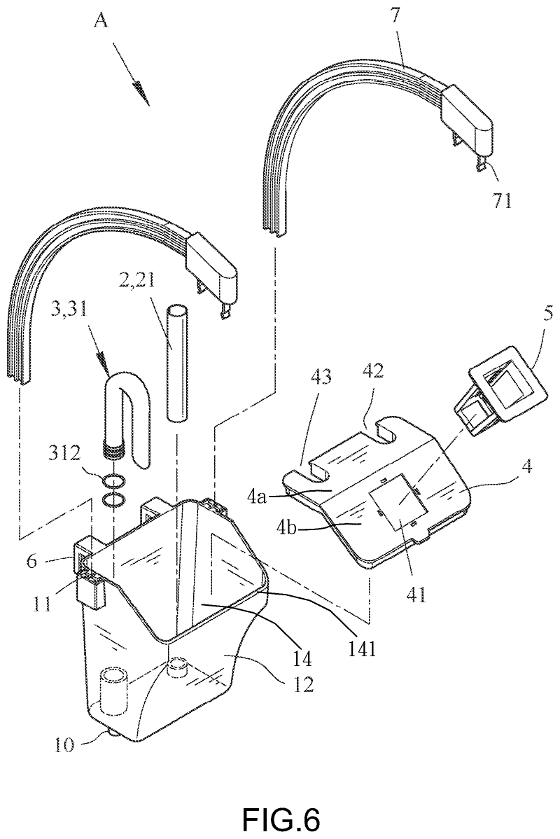

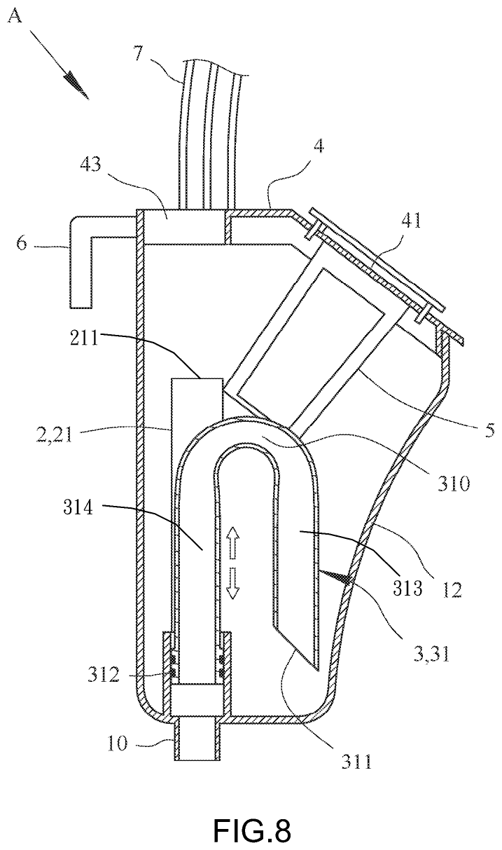

Referring to FIGS. 3 to 10, the container unit A for hydroponics of the present disclosure comprises a container 1 having an overflow unit 2 and an outflow unit 3 located therein. The overflow unit 2 includes an overflow tube 21, and the outflow unit 3 includes a siphon pipe 31 which is height adjustable. The overflow unit 2 includes an overflow tube 21, and the outflow unit 3 includes a siphon pipe 31 which is height adjustable. The outflow unit 3 includes an outlet 10 formed through the underside of the container 1. The siphon pipe 31 includes an inlet 311 formed in the first end(an end of the first straight section) thereof. The second end(an end of the second straight section) of the siphon pipe 31 is inserted into the outlet 10. Multiple seal rings 312 are located between the outlet 10 and the second end of the siphon pipe 31.

A cover 4 is mounted to the container 1 and has an opening 41, a first hole 42 and a second hole 43. A pot 5 is engaged with the opening 41 of the cover 4. At least one hook 6 is connected to the back of the container 1. The container 1 includes a reception part 11 on at least one side thereof. A light part 7 is inserted into the reception part 11 and includes a clip 71 so as to secure a light tube 8.

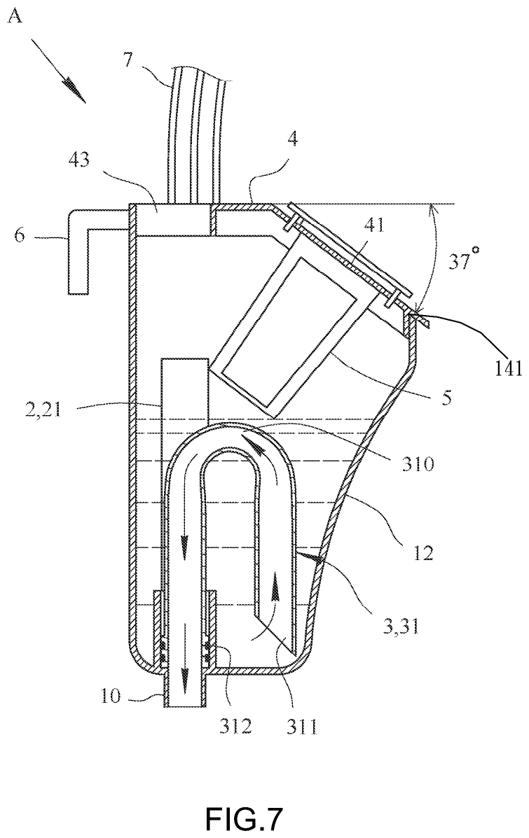

To further illustrate, the cover 4 of the container unit A for hydroponics has a top surface 4a and a beveled surface 4b, and the angle between the top surface 4a and the beveled surface 4b is between 35-40 degrees, and in the embodiment of the present disclosure, the angle is 37 degrees, allowing the container unit A to have a planting surface that is inclined outwardly at a 37-degree angle; as shown in FIG. 7, the lower portion of the container unit A is formed as a concaved and curved face 12, and the plants, after planting, will be inclined outwardly at an angle of 37 degrees and will be allowed to grow outwardly by taking advantage of the nature of the plants' tendency toward light.

In the embodiment of the present disclosure, the siphon pipe 31 in the container unit A is a U-shaped pipe having a U-section 310, a first straight section 313 and a second straight section 314 with a circular cross-sectional profile, see FIG. 3, the U-section 310 has a continuously varying cross-sectional profile (as shown by the cross-sectional lines A-A, B-B, C-C, D-D, and E-E), and the length of the long axis b of the U-section 310 is longest at the top position (i.e., at the cross-sectional line C-C) and the length of the long axis b is shortest at the two end positions (i.e., at the cross-sectional lines A-A and E-E) so that the cross-sectional profile of the U-section 310 exhibits a gradual change of elliptical profile, i.e., the cross-sectional profile of the U-section 310 is not the same for all of the U-sections 310 at any position. In the embodiment of the present disclosure, the cross-sectional profile of the U-section 310 is different from the cross-sectional profile of the two straight sections 313,314. In the embodiment of the present disclosure, the cross-sectional area of any position of the U-section 310 is substantially the same as the cross-sectional area of the two straight sections 313,314. In the embodiment of the present disclosure, the siphon pipe 31 is integrally molded.

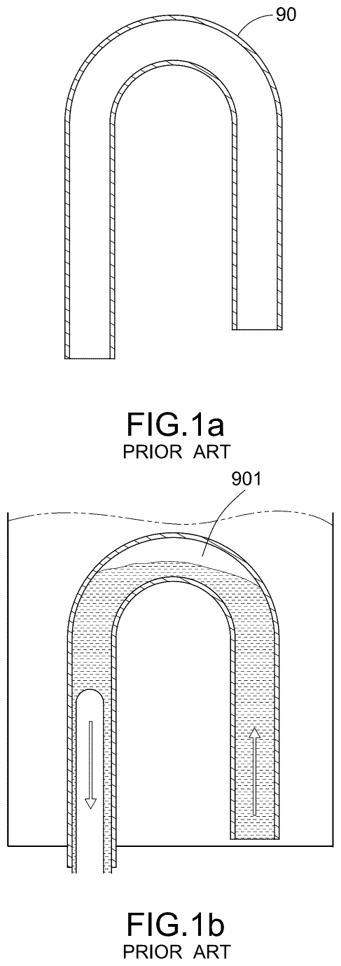

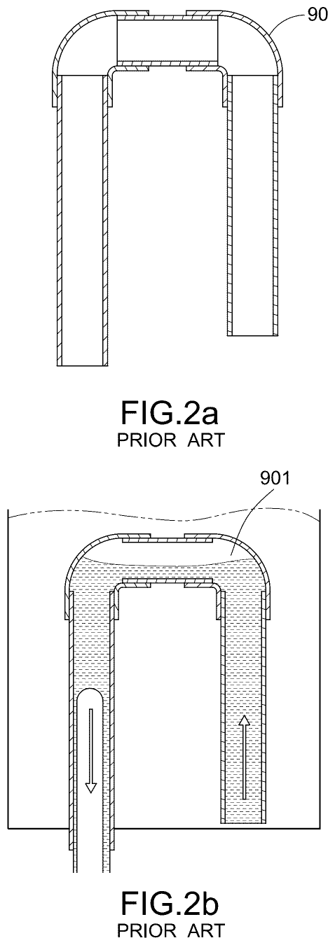

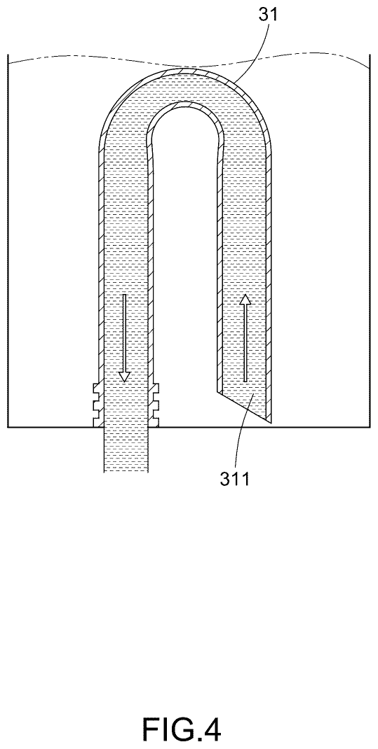

At the same time, referring to FIG. 4, when the water flows into the interior of the siphon pipe 31, the U-section 310 of the siphon pipe 31 will not accumulate air to create an air chamber so that the water can flow to pass through completely to achieve the full siphoning effect. Comparing the siphon pipe 90 of FIGS. 1a and 2a and the siphon pipe 31 of the present disclosure, under the condition that the diameter of both the outlet and inlet pipes is 13 mm, and the different siphon pipes 90, 31 are placed in the same container unit A, the minimum water intake of the siphon pipe 31 of the present disclosure for activating the siphoning effect is 9.60 (ml/sec), and that of the siphon pipe 90 of FIG. 1a is 20.21 (ml/sec), and that of the siphon pipe 90 of FIG. 2a is 33.95 (ml/sec). Accordingly, due to the siphon pipe 90 of FIGS. 1a and 2a produce the air chamber 901 and the formation of the air chamber 901 reduces the flow rate and volume of the drainage for siphoning, if the amount of water intake is insufficient, it will not be able to activate the siphoning effect, resulting in more water will be required to activate the siphoning effect; whereas the siphon pipe 30 of the present disclosure does not produce the air chamber so that the flow of the water can be completely passed through without the need of requiring a large amount of water to activate the siphoning effect therefore requires the least amount of water capable of achieving a water conservation effect.

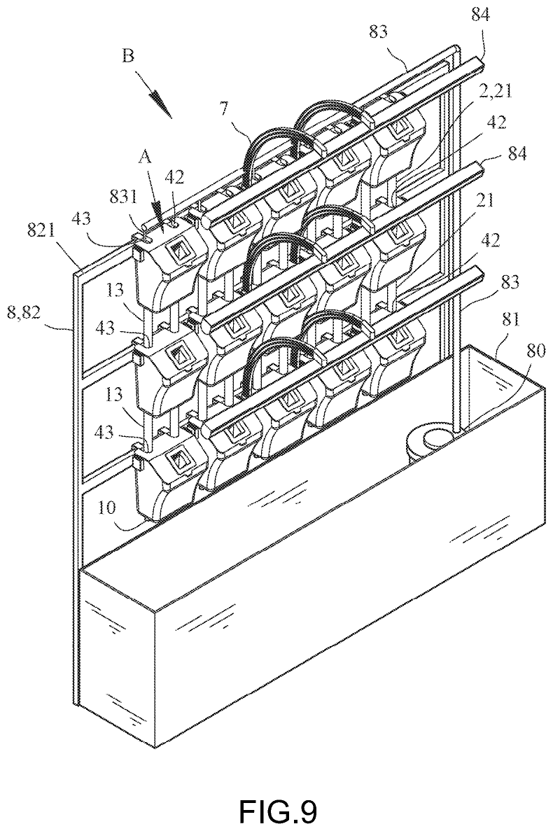

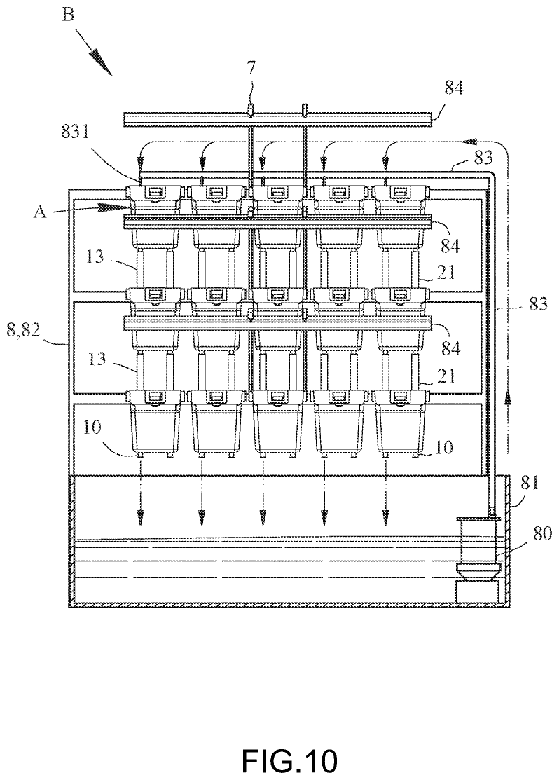

To further illustrate, in the container unit A for hydroponics, the height of an inlet 211 of the overflow tube 21 is located between the U-section 310 of the siphon pipe 31 and the lower edge 141 of an opening 14 of the container 1, so that when the siphon pipe 31 is clogged or sucked in by a foreign object, which causes the siphoning effect to fail, the overflow water can be discharged through the overflow tube 21 to prevent the water from flowing out of the opening 14 of the container 1.

Wherein, as shown in FIGS. 9 and 10, a container assembly B for hydroponics is disclosed and comprises a shelve 8 including a frame 82 which is connected to a water tank 81. The frame 82 includes multiple transverse bars 821. A feeding tube 83 has one end thereof connected with a motor 80 in the water tank 81 so as to pump nutrient solution or liquid from the water tank 81 to the container unit A.

A plurality of container units A are hooked to the transverse bars 821 by the at least one hook 6 of each container unit A so as to form at least two rows of containers 1 along the transverse bars 821. The feeding tube 83 includes multiple dripping tubes 831 which are respectively inserted into the second holes 43 of the container 1 of the first row of the container units A. The overflow tubes 21 of the containers 1 of the first row of the container units A are inserted into the first holes 42 of the containers 1 of the second row of the container units A. The second row of the container units A are located below the first row of the container units A. The outflow tube 13 is connected to the outlet 10 of each of the containers 1 of the first row of the container units A, and the outflow tubes 13 of the first row of the containers 1 are inserted into the second holes 43 of the containers 1 of the second row of the container units A. The outlet 10 of each container 1 of the second row of the container units A face the water tank 81. The shelve 8 may have multiple rows of the container units A which are interconnected by the overflow tubes 21 and the outflow tubes 13. Wherein, the light parts 7 are easily positioned to the container units A by the reception parts 11, and the light tubes 84 are secured to the light parts 7 which provide light to the plants in the pots 5 when desired in any season.

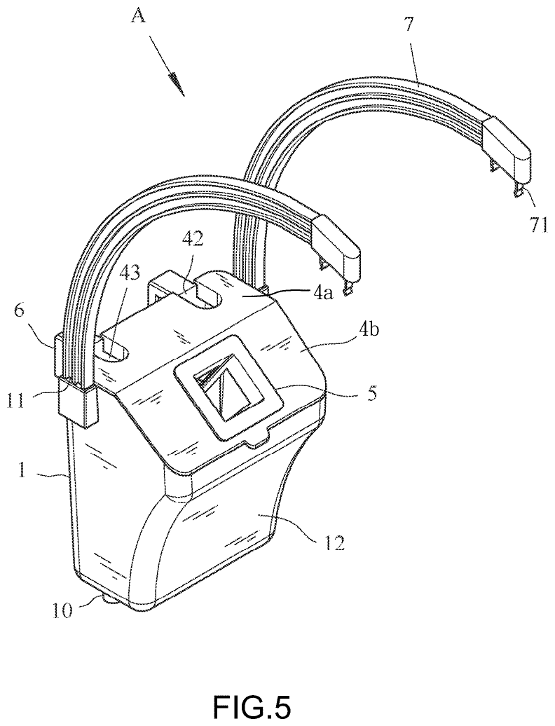

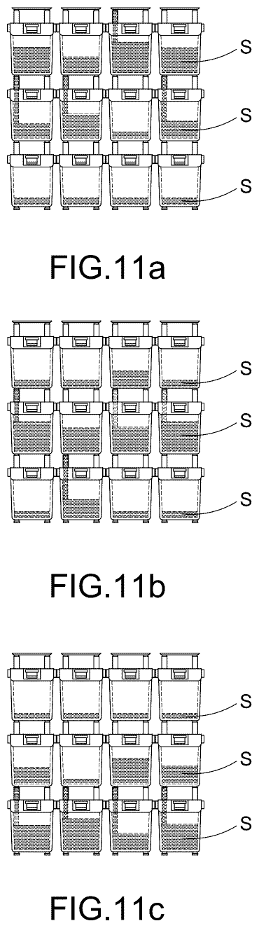

The operation of a container assembly B for hydroponics of the present disclosure utilizes the siphoning principle, as shown in FIGS. 5 to 8, the nutrient liquid are provided to the container units A via the dripping pipes 831 connected to the feeding tube 83. When the water level S of the nutrient liquid in one container 1 of the plurality of the container units A reaches the top of the siphon pipe 13, the siphon pipe 13 is operated so that the nutrient liquid in the container 1 flows downward to one container 1 of the plurality of the container units A of the lower row. As shown in FIGS. 11a, 11b and 11c, when the water level S of the upper row of one container 1 of the plurality of the container units A is lowered and below the inlet 311 of the siphon pipe 31, the siphon pipe 31 sucks air to stop the nutrient liquid from flowing out. The nutrient liquid eventually drops into the water tank 81 from the lowest row of the container units A. The water level S of the nutrient liquid in each container 1 is rise and fall regularly to let the plant roots to such the nutrients and air. The nutrient liquid circulates to provide nutrient to the plant, while the plant roots are protected from being rotted, which significantly increases the amount of dissolved oxygen in the water, allowing plant roots to fully absorb water nutrients and air, which helps plant root development.

The siphon pipe 31 can be adjusted according to different needs of different plants, and the seal rings 312 ensure the sealing feature so that the water level S can be precisely controlled.

In particular, the cross-sectional profile of the U-section 310 of the siphon pipe 31 has a length of the long axis b that is gradually lengthened from one end toward the top, and then the length of the long axis b that is gradually shrunken from the top toward the other end, thereby forming a continuously varying cross-sectional profile in the U-section 310 of the siphon pipe 31. When the water level S in the container 1 rises to the U-section 310 of the siphon pipe 31, the water level S in the siphon pipe 31 rises rapidly and flows to the outlet of the siphon pipe 31, and at the same time the air inside the siphon pipe 31 is brought out, to achieve a high-efficiency siphoning effect. Therefore, the siphon effect is effective and only limited nutrient liquid is required.

When a foreign object is sucked in the siphon pipe 31 and the siphon pipe 31 fails to normally operate, the water level is increased in one of the container 1 of the container units A and will flows to the lower row of one of the container 1 the container units A via the overflow tube 21. The overflow tube 21 and siphon pipe 31 control water level in the container 1 to prevent plant root from being rotted.

The plurality of traverse bars 821 of the present disclosure are arranged at intervals from top to bottom, so that the container assembly B of the present disclosure forms a vertical multi-layer planting mode, by using the siphoning principle as described above, the water level S in each container unit A installed on the traverse bars 821 rises to a predetermined height in sequence and flows to the lower layer of container unit A, in other words, each container unit A is independently siphoned and drained, as shown in FIGS. 11a to 11c, and finally leading to the water tank 81 for continuous circulation, the whole system requires only one layer of water consumption, which greatly reduces the water consumption required for the whole system.

When the container unit A for hydroponics provided with the siphon pipes of FIGS. 1a and 2a are used in the container assembly B for hydroponics, if the water intake of the container unit A provided with the siphon pipes of FIGS. 1a and 2a is insufficient to activate the siphoning effect, the water will be discharged along the wall of the siphon pipe 90 in an overflow mode, and the siphon pipe 90 in the lower waterway will continue to be discharged downward in the overflow mode due to the insufficient water intake to achieve the siphoning effect, which will cause the container assembly for hydroponics to fail to operate properly. Moreover, the container assembly B using the container unit A equipped with the siphon pipes 90 of FIGS. 1a and 2a cannot achieve the effect of independent siphoning and independent control of the water level for each individual container as in the present disclosure. The container unit A and the container assembly B for hydroponics using the siphon pipe 31 of the present disclosure can avoid this circumstance.

A light part 7 is inserted into the reception part 11 and includes a clip 71 so as to secure a light tube 84 as shown in FIG. 7, and the light tubes 84 are secured to the light parts 7 which provide light to the plants in the pots 5 when desired in any season.

The advantages of the present disclosure are that the shelves provide multiple rows of containers so as to increase production rate and reduce the problem that the upper container blocks the growth of planting on the lower container.

### Prior Art

90: siphon pipe
901: air chamber

### Present Disclosure

A-A,B-B,C-C,D-D,E-E: cross-sectional lines
A: container unit
S: water level
b: long axis
1: container
11: reception part
12: curved face
13: outflow tube
14: opening
141: lower edge
2: overflow unit
21: overflow tube
211: water inlet
3: outflow unit
31: siphon pipe
310: U-section
311: inlet
312: seal ring
313,314: straight section
4: cover
4a:top surface
4b:beveled surface
41: opening
42: first hole
43: second hole
6: hook
7: light part
71: clip
B: container assembly
8: shelve
80: motor
81: water tank
82: frame
821: transverse bar
83: feeding tube
831: dripping tube
84: light tube

What is claimed is:

1. A siphon pipe, which is applied to a container unit for hydroponics comprising a pipe which is an integrally molded U-shaped body, the pipe having a U-section and two straight sections, the U-section having a continuously varying cross-sectional profile and having the longest length of the long axis at the top position.

2. The siphon pipe as claimed in claim 1, wherein the U-section of the siphon pipe has the shortest length of the long axis at the two joint locations connecting the two straight sections.

3. The siphon pipe as claimed in claim 1, wherein the cross-sectional area at any position of the U-section of the siphon pipe is substantially the same as the cross-sectional area of the two straight sections.

4. The siphon pipe as claimed in claim 1, wherein the cross-sectional profile of the U-section of the siphon pipe is in the shape of a flat ellipse, and the cross-sectional profiles of the two straight sections are in the shape of a circle.

5. A container unit for hydroponics, comprising:
a container having an overflow unit and an outflow unit located therein, the overflow unit including an overflow tube, the outflow unit including a siphon pipe;
wherein the siphon pipe is an integrally molded U-shaped pipe comprising a U-section and two straight sections;
wherein the U-section has a continuously varying cross-sectional profile and the longest length of the long axis at the top position, and the height of the top end position of the U-section does not exceed the height of an inlet of the overflow tube.

6. The container unit as claimed in claim 5, wherein the position of a water inlet of the overflow tube is between the top of the U-section of the siphon pipe and a lower edge of an opening of the container.

7. The container unit as claimed in claim 5, wherein the height of the siphon pipe is adjustable.

8. The container unit as claimed in claim 5, wherein an end of a first straight section of the siphon pipe is an inlet, an end of a second straight section of the siphon pipe is inserted into an outlet which is formed through an underside of the container.

9. The container unit as claimed in claim 5, wherein a cover for closing an opening of the container, and a pot engaged with an opening of the cover.

10. The container unit as claimed in claim 9, wherein the cover has a first hole and a second hole.

11. The container unit as claimed in claim 9, wherein the cover has a top surface and a beveled surface, the angle between the top surface and the beveled surface being between 35 and 40 degrees.

12. The container unit as claimed in claim 11, the angle between the top surface and the beveled surface being 37 degrees.

13. The container unit as claimed in claim 9, a concaved and curved face is formed to a front face of the container.

14. A container assembly for hydroponics, comprising:
a plurality of container units, a water tank, and a shelve;
wherein each of the container units including a container having an overflow unit and an outflow unit, the overflow unit having an overflow tube, and the outflow unit having a siphon pipe which is an integrally molded U-shaped pipe including both of a U-section and two straight sections, the U-section having a continuously varying cross-sectional profile and having the longest length of the long axis at the top position, and the height of the U-section not exceeding the height of an inlet of the overflow tube;
wherein the shelve is provided with a frame at one side of the water tank and extends upwardly having a plurality of transverse bars arranged in a matrix arrangement, and a feeding tube corresponding to the transverse bar having one end connected to a sinking motor in the water tank;
wherein the container units are spaced apart on each of the transverse bars so that the container units are arranged in a matrix arrangement on the frame, and the feeding tube is provided with a dripping tube corresponding to a second inlet of each container unit on the uppermost row, and the overflow tube of the overflow unit of each container unit which is not on the uppermost row is connected to a first inlet corresponding to each of the container units on the next row, and an outflow tube of the container of each container unit which is not on the uppermost row is connected to a second inlet corresponding to each of the container units on the next row.

15. The container assembly for hydroponics as claimed in claim 14, wherein at least two light parts are connected to the transverse bar, each light part includes a light tube.

16. The container assembly for hydroponics as claimed in claim 15, wherein the height of the light part is adjustable.
